(19) United States
(12) Patent Application Publication
(10) Pub. No.: US 2018/0292815 A1
(43) Pub. Date: Oct. 11, 2018

(54) SYSTEMS AND METHODS FOR CHECKING COMPUTER-AIDED DESIGN MODELS

(71) Applicant: General Electric Company, Schenectady, NY (US)

(72) Inventors: Jason Anton Byers, Greenville, SC (US); Brian Christopher Wheeler, Simpsonville, SC (US); Kena Yokoyama, Simpsonville, SC (US); John Madison Tramel, JR., Roebuck, SC (US)

(21) Appl. No.: 15/480,138

(22) Filed: Apr. 5, 2017

(51) Int. Cl. G05B 23/02; G05B 13/04

(52) U.S. Cl. CPC G05B 23/0208; G05B 13/04

(57) ABSTRACT

A system includes memory and a processor. The processor is configured to receive a first file associated with a computer-aided design (CAD) model, and the first file includes a first set of programming object data. The processor is also configured to receive at least one second file that is associated with the CAD model and comprises a second set of programming object data. Additionally, the processor is configured to compare the first set of programming object data to the second set of programming object data and generate a third file or a graphical representation of the CAD model that includes one or more graphical representations indicative of one or more differences between the first set of programming object data and the second set of programming object data.

### BACKGROUND

The subject matter disclosed herein relates to systems and methods for design and inspection of parts, such as industrial machine parts.

Industrial machines, such as gas turbine systems, may provide for the generation of power. For example, the gas turbine systems typically include a compressor for compressing a working fluid, such as air, a combustor for combusting the compressed working fluid with fuel, and a turbine for turning the combusted fluid into a rotative power. For example, the compressed air is injected into a combustor, which heats the fluid causing it to expand, and the expanded fluid is forced through the gas turbine. The gas turbine may then convert the expanded fluid into rotative power, for example, by a series of blade stages. The rotative power may then be used to drive a load, which may include an electrical generator producing electrical power and electrically coupled to a power distribution grid. Industrial machines and machine parts may be designed for a particular purpose, such as a compressor blade designed to compress air. The machine or part may undergo inspection for its ability to fulfill its design purpose.

### BRIEF DESCRIPTION

Certain embodiments commensurate in scope with the original claims are summarized below. These embodiments are not intended to limit the scope of the claims, but rather these embodiments are intended only to provide a brief summary of possible forms of the embodiments described herein. Indeed, the embodiments described herein may encompass a variety of forms that may be similar to or different from the embodiments set forth below.

In a first embodiment, a non-transitory, machine-readable medium includes instructions configured to cause a processor to receive a first file associated with a computer-aided design (CAD) model. The first file includes a first set of programming object data indicative of one or more properties of one or more components of the CAD model. The instructions are configured to cause the processor to receive at least one second file that is associated with the CAD model and includes a second set of programming object data associated with at least one of the one or more properties. The instructions are configured to cause the processor to compare the first set of programming object data to the second set of programming object data and generate a third file or a graphical representation of the CAD model that includes one or more graphical representations indicative of one or more differences between the first set of programming object data and the second set of programming object data.

In another embodiment, a system includes memory and a processor. The processor is configured to receive a first file associated with a computer-aided design (CAD) model, and the first file includes a first set of programming object data. The processor is also configured to receive at least one second file that is associated with the CAD model and comprises a second set of programming object data. Additionally, the processor is configured to compare the first set of programming object data to the second set of programming object data and generate a third file or a graphical representation of the CAD model that includes one or more graphical representations indicative of one or more differences between the first set of programming object data and the second set of programming object data.

In yet another embodiment, a method includes receiving, via a processor, a first file associated with a computer-aided design (CAD) model, and the first file includes a first set of programming object data. The method also includes receiving, via the processor, at least one second file that includes at least one second file is associated with the CAD model and includes a second set of programming object data. Additionally, the method includes comparing, via the processor, the first set of programming object data to the second set of programming object data and generating, via the processor, a third file or a graphical representation of the CAD model that includes one or more graphical representations indicative of one or more differences between the first set of programming object data and the second set of programming object data.

### BRIEF DESCRIPTION OF THE DRAWINGS

These and other features, aspects, and advantages of the present application will become better understood when the following detailed description is read with reference to the accompanying drawings in which like characters represent like parts throughout the drawings, wherein:

FIG. 1 is a block diagram of an embodiment of a computer-aided technology (CAx) system, in accordance with embodiments described herein;

FIG. 2 is a block diagram of a certain components of the CAx system of FIG. 1, in accordance with embodiments described herein;

FIG. 3 is a block diagram of an industrial system that may be conceived, designed, engineered, manufactured, and/or serviced and tracked by the CAx system of FIG. 1, in accordance with embodiments described herein;

FIG. 4 is a block diagram of a process for generating a new file that is indicative of the differences between an edited file and a first file, in accordance with embodiments described herein;

FIG. 5 is a flow chart of a method for checking files against a first file and generating a new file based on the differences between the edited files and the first file, in accordance with embodiments described herein; and

FIG. 6 is a diagram of graphical content associated with an edited file displayed via execution of a computer-aided design checking application, in accordance with embodiments described herein.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Generating a machine or part may include certain systems and methods described in more detail below that produce a part design. For example, the part design may be created as a model-based definition included in a 3-dimensional (3D) computer-aided design (CAD) model. After creating the part design, others may review and edit the part design using a CAD checking application. The CAD checking application may allow for various versions of the part design to be gathered and compared to another part design (e.g., an original part design). The CAD checking application may also display a CAD model of the part design that includes graphical indications of differences between different versions of the part design. By allowing for comparisons to be made among several versions of CAD models of the part design, the part model may be configured, reviewed, and modified more efficiently and accurately.

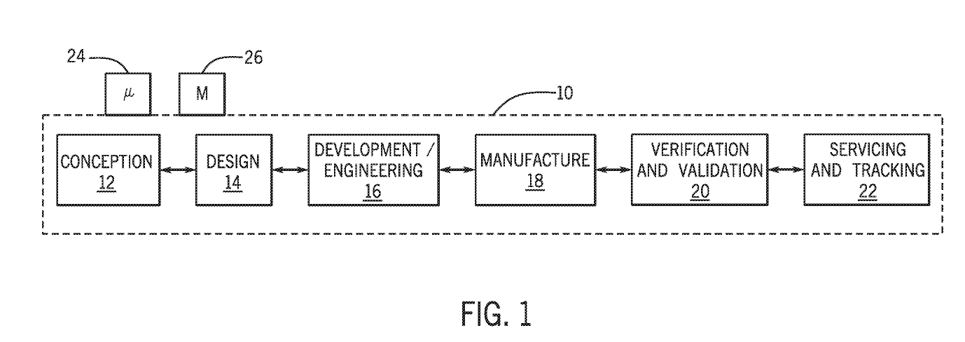

With the foregoing in mind, it may be useful to describe a computer-aided technologies (CAx) system that may incorporate the techniques described herein, for example to improve the design, review, and modification of models. Accordingly, FIG. 1 illustrates an embodiment of a CAx system 10 suitable for providing for a variety of processes, including product lifecycle management (PLM) processes 12, 14, 16, 18, 20, 22. In the depicted embodiment, the CAx system 10 may include support for execution of conception processes 12. For example, the conception processes 12 may produce a set of specifications such as requirements specifications documenting a set of requirements to be satisfied by a design, a part, a product, or a combination thereof. The conception processes 12 may also produce a concept or prototype for the part or product (e.g., machine). A series of design processes 14 may then use the specifications and/or prototype to produce, for example, one or more three-dimensional (3D) design models of the part or product. The 3D design models may include solid/surface modeling, parametric models, wireframe models, vector models, non-uniform rational basis spline (NURBS) models, geometric models, 2-dimensional models (2D) manufacturing part and assembly drawings, and the like.

Design models may then be further refined and added to via the execution of development/engineering processes 16. The development/engineering processes 16 may, for example, create and apply models such as thermodynamic models, low cycle fatigue (LCF) life prediction models, multibody dynamics and kinematics models, computational fluid dynamics (CFD) models, finite element analysis (FEA) models, and/or 3-dimension to 2-dimension FEA mapping models that may be used to predict the behavior of the part or product during its operation. For example, turbine blades may be modeled to predict fluid flows, pressures, clearances, and the like, during operations of a gas turbine engine. The development/engineering processes 16 may additionally result in tolerances, materials specifications (e.g., material type, material hardness), clearance specifications, and the like.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, and the like, to create the part or product. Other manufacturing models may be derived, such as computer numeric control (CNC) models with G-code to machine or otherwise remove material to produce the part or product (e.g., via milling, lathing, plasma cutting, wire cutting, and so on). Bill of materials (BOM) creation, requisition orders, purchasing orders, and the like, may also be provided as part of the manufacture processes 18 (or other PLM processes).

The CAx system 10 may additionally provide for verification and/or validation processes 20 that may include automated inspection of the part or product as well as automated comparison of specifications, requirements, and the like. In one example, a coordinate-measuring machine (CMM) process may be used to automate inspection of the part or product. After the part is inspected, results from the CMM process may be automatically generated via an electronic Characteristic Accountability & Verification (eCAV) system.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to reconfigure the part or product via the design processes 14. Indeed, data from any one of the processes 12, 14, 16, 18, 20, 22 may be used by any other of the processes 12, 14, 16, 18, 20, 22 to improve the part or product or to create a new part or a new product. In this manner, the CAx system 10 may incorporate data from downstream processes and use the data to improve the part or to create a new part.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

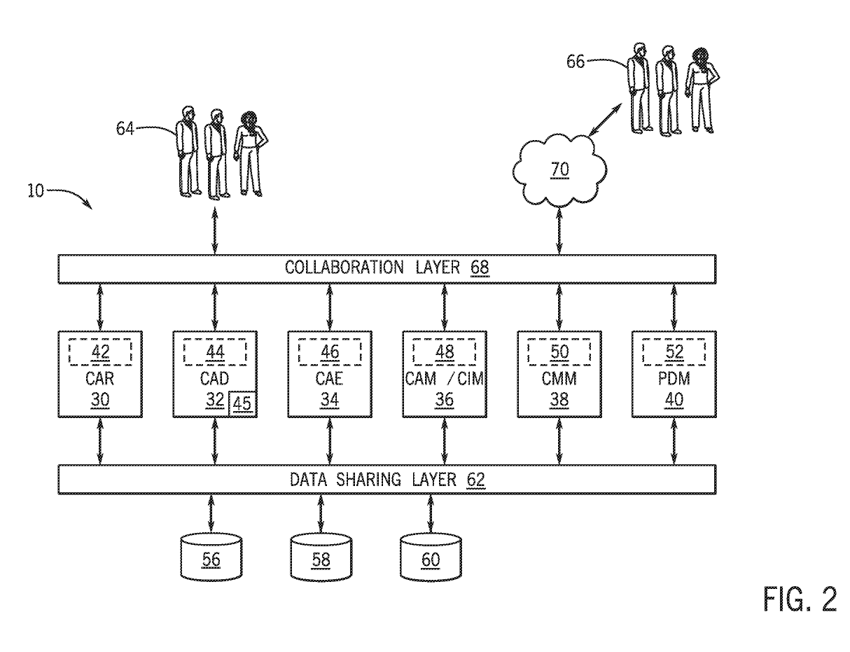

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40. Each of the systems 30, 32, 34, 36, 38 and 40 may be extensible and/or customizable; accordingly, each system 30 may include an extensibility and customization system 42, 44, 46, 48, 50, and 52, respectively. Additionally, each of the systems 30, 32, 34, 36, 38 and 40 may be stored in a memory system, such as memory system 26, and may be executable via a processor, such as via processors 24.

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models as described above with respect to the design processes 14. For example, the 3D models may include solid/surface modeling, parametric models, wireframe models, vector models, non-uniform rational basis spline (NURBS) models, geometric models, and the like. The CAD system 32 may provide for the creation and updating of the 2D and/or 3D models and related information (e.g., views, drawings, annotations, notes, and so on). Indeed, the CAD system 32 may combine a graphical representation of the part or product with other, related information. The CAD system 32 may include a CAD checking application 45 that, when executed by the processors 24, may allow users to review and edit a first 2D or 3D model as well as compare the reviewed and/or edited models to the first model. More specifically, the 2D and 3D models may include programming objects, and the CAD checking application 45 may allow for programming objects in different versions of a model to be compared. Furthermore, edits, such as comments, annotations, and correction, may be displayed with the model. Additionally, as discussed in detail below, the CAD checking application 45 may allow for a detailed list to be displayed to a user that indicates how the first model compares to another user's reviewed and/or edited model.

The CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics and kinematics models, computational fluid dynamics (CFD) models, finite element analysis (FEA) models, and/or 3-dimension to 2-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof. The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, and/or 38. For example, the systems 30, 32, 34, 36, and/or 38 may communicate with data repositories 56, 58, 60 via a data sharing layer 62. The PDM system 40 may then manage collaboration between the systems 30, 32, 34, 36, and/or 38 by providing for data translation services, versioning support, archive management, notices of updates, and so on. The PDM system 40 may additionally provide for business support such as interfacing with supplier/vendor systems and/or logistics systems for purchasing, invoicing, order tracking, and so on. The PDM system 40 may also interface with service/logging systems (e.g., service center data management systems) to aid in tracking the maintenance and life cycle of the part or product as it undergoes operations. Teams 64, 66 may collaborate with team members via a collaboration layer 68. The collaboration layer 68 may include web interfaces, messaging systems, file drop/pickup systems, and the like, suitable for sharing information and a variety of data. For instance, team members may collaborate to review and modify a first model via the collaboration layer 68, resulting in several different reviewed and/or edited versions of the model, and the CAD checking application 45 may generate a new file that includes a CAD model that denotes all of the reviewing and edits completed by team members. The collaboration layer 68 may also include cloud-based systems 70 or communicate with the cloud-based systems 70 that may provide for decentralized computing services and file storage. For example, portions (or all) of the systems 30, 32, 34, 36, 38 may be stored in the cloud 70 and/or accessible via the cloud 70.

The extensibility and customization systems 42, 44, 46, 48, 50, and 52 may provide for functionality not found natively in the CAR system 30, the CAD system 32, the CAM/CIM system 36, the CMM system 38 and/or the PDM system 40. For example, computer code or instructions may be added to the systems 30, 32, 34, 36, and/or 38 via shared libraries, modules, software subsystems and the like, included in the extensibility and customization systems 42, 44, 46, 48, 50, and/or 52. The extensibility and customization systems 42, 44, 46, 48, 50, and 52 may also use application programming interfaces (APIs) included in their respective systems 30, 32, 34, 36, and 38 to execute certain functions, objects, shared data, software systems, and so on, useful in extending the capabilities of the CAR system 30, the CAD system 32, the CAM/CIM system 36, the CMM system 38 and/or the PDM system 40. By enabling the processes 12, 14, 16, 18, 20, and 22, for example, via the systems 30, 32, 34, 36, and 38 and their respective extensibility and customization systems 42, 44, 46, 48, 50, and 52, the techniques described herein may provide for a more efficient “cradle-to-grave” product lifecycle management.

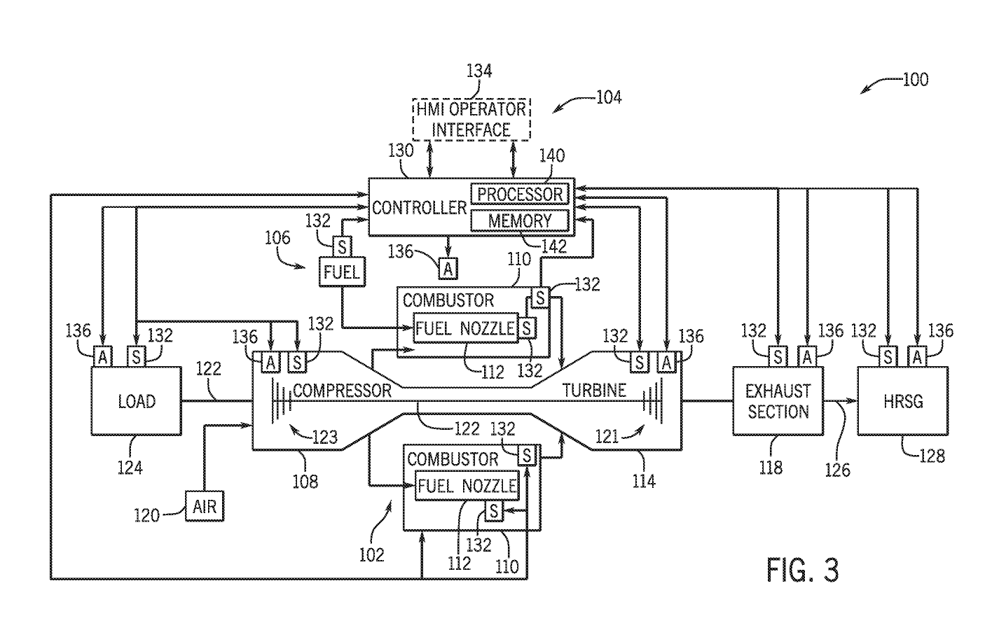

It may be beneficial to describe a machine that would incorporate one or more parts manufactured and tracked by the processes 12, 14, 16, 18, 20, and 22, for example, via the CAx system 10. Accordingly, FIG. 3 illustrates an example of a power production system 100 that may be entirely (or partially) conceived, designed, engineered, manufactured, serviced, and tracked by the CAx system 10. As illustrated in FIG. 1, the power production system 100 includes a gas turbine system 102, a monitoring and control system 104, and a fuel supply system 106. The gas turbine system 102 may include a compressor 108, combustion systems 110, fuel nozzles 112, a gas turbine 114, and an exhaust section 118. During operation, the gas turbine system 102 may pull air 120 into the compressor 108, which may then compress the air 120 (e.g., via a series of compressor stages 123) and move the air 120 to the combustion system 110 (e.g., which may include a number of combustors). In the combustion system 110, the fuel nozzle 112 (or a number of fuel nozzles 112) may inject fuel that mixes with the compressed air 120 to create, for example, an air-fuel mixture.

The air-fuel mixture may combust in the combustion system 110 to generate hot combustion gases, which flow downstream into the turbine 114 to drive one or more turbine stages. For example, the combustion gases may move through the turbine 114 to drive one or more stages of turbine blades 121, which may in turn drive rotation of a shaft 122. The shaft 122 may connect to a load 124, such as a generator that uses the torque of the shaft 122 to produce electricity. After passing through the turbine 114, the hot combustion gases may vent as exhaust gases 126 into the environment by way of the exhaust section 118. The exhaust gas 126 may include gases such as carbon dioxide (CO₂), carbon monoxide (CO), nitrogen oxides (NOₓ), and so forth.

The exhaust gas 126 may include thermal energy, and the thermal energy may be recovered by a heat recovery steam generation (HRSG) system 128. In combined cycle systems, such as the power production system 100, hot exhaust 126 may flow from the gas turbine 114 and pass to the HRSG 128, where it may be used to generate high-pressure, high-temperature steam. The steam produced by the HRSG 128 may then be passed through a steam turbine engine for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the power production system 100 may also include a controller 130. The controller 130 may be communicatively coupled to a number of sensors 132, a human machine interface (HMI) operator interface 134, and one or more actuators 136 suitable for controlling components of the power production system 100. The actuators 136 may include valves, switches, positioners, pumps, and the like, suitable for controlling the various components of the system 100. The controller 130 may receive data from the sensors 132, and may be used to control the compressor 108, the combustion system 110, the turbine 114, the exhaust section 118, the load 124, the HRSG 128, and so forth.

In certain embodiments, the HMI operator interface 134 may be executable by one or more computer systems of the power production system 100. A plant operator may interface with the power production system 100 via the HMI operator interface 134. Accordingly, the HMI operator interface 134 may include various input and output devices (e.g., mouse, keyboard, monitor, touch screen, or other suitable input and/or output device) such that the plant operator may provide commands (e.g., control and/or operational commands) to the controller 130.

The controller 130 may include a processor(s) 140 (e.g., a microprocessor(s)) that may execute software programs to perform the disclosed techniques. Moreover, the processor 140 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 130 may include a memory device 142 that may store information such as control software, look up tables, configuration data, etc. The memory device 142 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

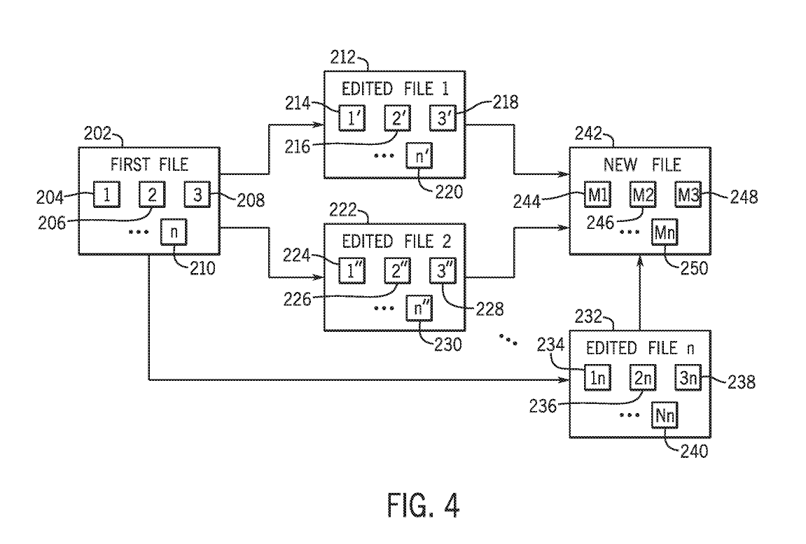

Components of the power production system 100 may be modeled using the CAD system 32 as part of the design processes 14. During the design processes 14 or other PLM processes such as, but not limited to, the development/engineering processes 16 and the manufacturing processes 18, several users, such as team members, may review and/or edit a design made by another user. With this in mind, FIG. 4 is a block diagram of a process 200 for generating a new file that is indicative of the differences between an edited file and a first file. The process 200 may be performed by the CAD checking application 45. A first file 202 may include a 2D and/or 3D CAD model as well as programming objects 204, 206, 208, 210 associated with the CAD model. The CAD file may include any suitable number of programming objects. In one example, the first file 202 may include a model of a component of the power production system 100, and the programming objects 204, 206, 208, 210 may pertain to various components or elements of the component. In other words, the programming objects 204, 206, 208, 210 may be programming objects associated with the same version (e.g., a first version) of a 2D or 3D model. The programming objects 204, 206, 208, 210 may include attributes or properties that may be edited by users, such as team members of the teams 64, 66. For example, the programming object 204 may pertain to a feature, a measurement or dimension associated with a component. A user may edit the measurement or dimension utilizing the CAD system 32, and an attribute or attributes of the corresponding object or objects may be modified to reflect the user's modification. The attributes may include data concerning programming objects. For instance, the attributes may include, among other things, data regarding a name of a programming object, a font and/or font size associated with the programming object, dimensions related to an aspect of a model, and/or user input (e.g., notes or comments) associated with the programming object.

Other users, such as members of the teams 64, 66, may review and/or edit the first file 202. Continuing with the example of the first file 202 including a model of a component of the power production system 100, one member of the team 64 may have generated the first model (i.e., one team member is the author of the first file 202). Other members of the team 64 or members of team 66 may be engineers or other people associated with the design, engineering, testing, and manufacturing of the component, and they may review and/or modify the design of the component. For instance, each of the members of the teams 64, 66 may receive the first file 202 (e.g., via the network 70). A first team member may review and/or edit the first file 202, resulting in edited file 212 (e.g., a second file). A second team member may review and/or edit the first file 202, resulting in edited file 222. As such, in one embodiment, a new file may be generated for each person who reviews and/or edits the first file 202, and the last person to edit and/or review the first file 202 may cause a last edited file 232 to be generated.

Each of the edited files 212, 222, 232 may include programming objects corresponding to the first model of the first file 202. In other words, the edited files 212, 222, 232 may include any of the programming objects 204, 206, 208, 210 provided in the first file 202. Additionally, the edited files 212, 222, 232 may include programming objects indicative of reviewing and/or modifying the first model 202. That is, the edited files 212, 222, 232 may include objects that are modified versions of the programming objects 204, 206, 208, 210. For instance, in the illustrated embodiment, the first edited file 212 includes programming objects 204, 216, 218, 220, the second edited file 222 includes programming objects 224, 226, 228 230, and the last edited file 232 includes programming objects 234, 236, 238, 240. The programming objects 224, 234 are modified versions of the programming object 204; the programming objects 216, 226, 236 are modified versions of the programming object 206; the programming objects 218, 228, 238 are modified versions of the programming object 208; the programming objects 220, 230, 240 are modified versions of the programming object 210. While reviewing and/or editing is discussed is greater detail below, it should be noted the programming objects 216, 218, 220, 224, 226, 228, 230, 234, 236, 238, and 240 differ from one of the programming objects 204, 206, 208, and 210 of the first file 202 in at least one manner.

For instance, an attribute of the programming object 206 may be edited by a user, resulting in the programming object 216 to be generated. More specifically, a team member may check the first model of the first file 202 and agree with the first model, which may result in one or more of the programming objects 216, 218, 220, 224, 226, 228, 230, 234, 236, 238, 240 to be generated. In other words, a user may view the first model 202 and determine whether the user thinks the first model is correct. If the user thinks the first model 202 is correct, the user may use a tool provided by the CAD checking application 45 to indicate that the user agrees with the first model 202. Such an indication may cause the CAD checking application to generate one or more programming objects (e.g., one or more of the programming objects 216, 218, 220, 224, 226, 228, 230, 234, 236, 238, 240) that may reflect the user input indicating that the user thinks the first model is correct 202. However, in other embodiments, a user's indication of agreement with a programming object of the first model may not cause another programming object to be generated.

As another example, the team member may annotate part of the model or note a request for a correction, in which case one or more of the one or more of the programming objects 216, 218, 220, 224, 226, 228, 230, 234, 236, 238, 240 may be generated. For instance, a user reviewing the first model 202 may determine that the user does not agree with one or more aspects of the first model 202. The user may indicate such a disagreement via a tool provided by the CAD checking application 45, and the user may specify how the user would like for the first model 202 to be modified. The CAD checking application 45 may generate programming objects that reflect the user input indicative of a request for a correction to be made.

It should also be noted that the review and/or editing of a user may cause a programming object that does not correspond to one of the programming objects 204, 206, 208, 210 to be generated. For instance, a user may indicate, via the CAD checking application 45, that a model a part or component should be added to the first model 202. Such an indication may cause a programming object corresponding to the requested addition of a part or component to be generated. However, because the part requested to be added does not exist in the first model 202, a programming object that does not correspond to one of the programming objects 204, 206, 208, 210 to be generated.

In any case, the CAD checking application 45 may allow for the edited files 212, 222, 232 to be compared to the first file 202 to generate new file 242 (e.g., a third file), which, when executed by the processors 24, may show the results of the reviewing and editing made by the team members. In other words, the CAD checking application 45 may compare the programming objects 216, 218, 220, 224, 226, 228, 230, 234, 236, 238, 240 of the edited files 212, 222, 232 to the programming objects 204, 206, 208, 210 of the first file 202 and generate a new file 242 that reflects the differences and similarities between the edited files 212, 222, 232 and the first file 202. More specifically, the new file 242 includes programming objects 244, 246, 248, 250, and each of the programming objects 244, 246, 248, 250 may reflect the differences and similarities between the programming objects 216, 218, 220, 224, 226, 228, 230, 234, 236, 238, 240 of the edited files 212, 222, 232 and the programming objects 204, 206, 208, 210 of the first file 202. For instance, the programming objects 244 may reflect that the first team member did not review or edit the programming object 204 and that the second and last team members reviewed and/or edited the programming object 204, resulting in the programming objects 224, 234 to be generated, respectively. That is, the CAD checking application 45 may note when a user does not review and/or edit a programming object 204, 206, 208, 210 of the first file 202. Additionally, the programming objects 244, 246, 248, 250 may include a corresponding programming object or one or more attributes of a corresponding programming object. For example, the programming object 244 may include the programming objects 224, 234 and/or any of the attributes of the programming objects 224, 234.

The CAD checking application 45 may also allow for programming objects 216, 218, 220, 224, 226, 228, 230, 234, 236, 238, 240 to be classified based on how the programming objects 216, 218, 220, 224, 226, 228, 230, 234, 236, 238, 240 differ from the programming objects 204, 206, 208, 210. For example, a difference between the programming object 216 and the programming object 206 may be that the programming object 216 is a reviewed version of the programming object 206. As another example, the programming object 208 may differ from the programming object 218 in that the programming object 218 is indicative of an edit from the first team member noting that an attribute of the programming object 208 should be corrected. For instance, the first team member may note that a component of the model of the first file 202 corresponding to the programming object 208 did not include a tolerance that should have been included. The first team member may note that such a tolerance is absent and that the tolerance should be added in the edited file 212 and reflected by the programming object 218. As yet another example, the CAD checking application 45 may allow for the programming objects to be categorized based on an edit that does not correspond to correction. In other words, a user may add a comment, note, or annotation to the model (e.g., indicating a preference or something that the user does not think should be corrected but for which the user would otherwise like to comment), such a comment, note, or annotation may be reflected in a programming object (e.g., the programming object 220), and the CAD checking application 45 may allow for the corresponding programming object in the new file 242 (e.g., the programming object 250) to be indicative that the programming object differs from a corresponding programming object in the first file 202 (e.g., the programming object 210) due to the comment, note, or annotation.

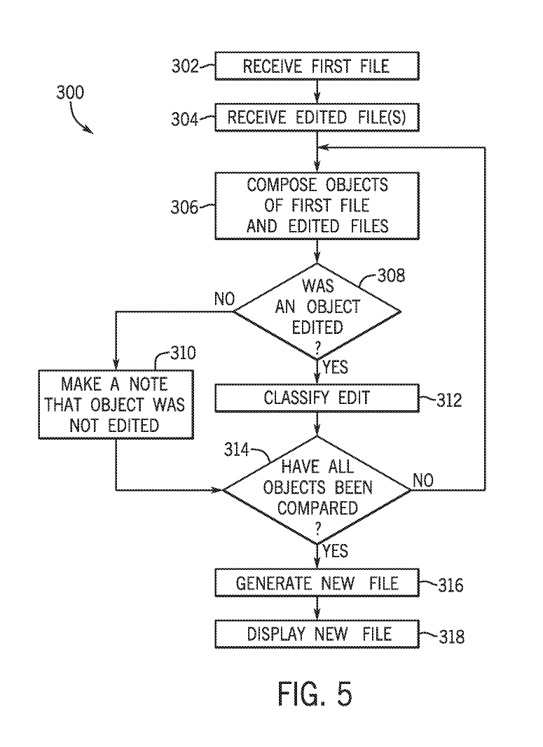

Keeping the discussion related to FIG. 4 in mind, FIG. 5 is a flow chart of a method 300 for checking files against a first file and generating a new file based on the differences between the edited files and the first file. The method 300 may be performed by processors executing the CAD checking application 45 (e.g., processors 24). Any suitable processor or application may perform the method 300. Additionally, the method 300 may be performed in any suitable order.

At block 302, the processors 24 may receive a first CAD file (e.g., first file 202). As described above, the first CAD file may include programming objects associated with a 2D or 3D CAD model, and the programming objects may include attributes. The programming objects may correspond to specific aspects of the first CAD model. The attributes may include data associated with the specific aspects of a particular programming object.

At block 304, the processors 24 may receive edited versions of the first CAD file (e.g., edited files 212, 222, 232). Executing the CAD checking application 45, the processors 24 may compare the programming object of the edited CAD files (e.g., the programming objects 216, 218, 220, 224, 226, 228, 230, 234, 236, 238, 240) to the programming objects of the first CAD file (e.g., the programming objects 204, 206, 208, 210. That is, by executing the CAD checking application 45, the processors 24 may determine whether the programming objects of the edited CAD files differ from the programming objects of the first CAD file.

At block 308, the processors 24 may determine whether a programming object was edited. In other words, the processors 24 may determine whether a programming object of the edited CAD files is an edited version of one or more of the programming objects of the first CAD file. For instance, the processors 24 may determine that the programming object 204 of the edited file 212 is the same as the programming object 204 of the first file 202. In such a case, as indicated by block 310, the processors 24 may generate an indication that the programming object of the edited file is not an edited version of the programming object of the first file.

However, if, at block 308, the processors 24 determine that a programming object has been edited, at block 312, the processors 24 may determine how the programming object was edited and classify the edit or edits. For instance, the processors 24 may determine that the programming object 224 of the second edited file 222 is an edited version of the programming object 204 of the first file 202, determine that the edit corresponds to the programming object 204 having been reviewed, and classify the edit as a being indicative of a user having reviewed the programming object 204. Such determinations and classifications may be stored on the memory 26 or in another location (e.g., the network 70).

In some embodiments, the CAD checking application 45, via the processors 24, may generate a new object indicative of how a programming object of an edited file differs from a programming object of the first file. That is, the CAD checking application 45 may allow for a programming object to be generating based on each comparison of a programming object of a first file to a programming object of an edited file. Each of the generated programming objects may later be combined or compiled to generate the programming objects found in the new file (e.g., the programming objects 244, 246, 248, 250 of the new file 242).

Continuing with the method 300, at block 314, the processors 24 may determine whether each of the programming objects of edited files has been compared the programming objects of the first file. If the processors 24 determine that each of the programming objects has not been compared, then the processors 24 may continue to compare programming objects as discussed above with regard to block 306. However, if the processors 24 determine that each of the programming objects of edited files has been compared to the programming objects of the first file, at block 316, a new file may be generated. As discussed above, the new file includes programming objects that reflect the differences and similarities between the programming objects of the edited files and the programming objects of the first files. In some embodiments, the new file may be visualized by the processors 24 as shown in FIG. 4. At block 318, the new file may be displayed (e.g., via a monitor, tablet, smartphone, television, or other display). Based on the programming objects of the new file, the new file may allow a team member to see how another team member has reviewed, edited, commented, annotated, or otherwise modified the first file. For example, the edits, comments, annotations, and review of other users may be displayed with the model of the first file. In some embodiments, the various types of review, edits, comments, and annotations may be displayed in colors. For instance, one color may be used to reflect that a user has indicated the user agrees a particular aspect of the model of the first file while another color may be used to reflect that a user has requested that another aspect of the model of the first file be changed.

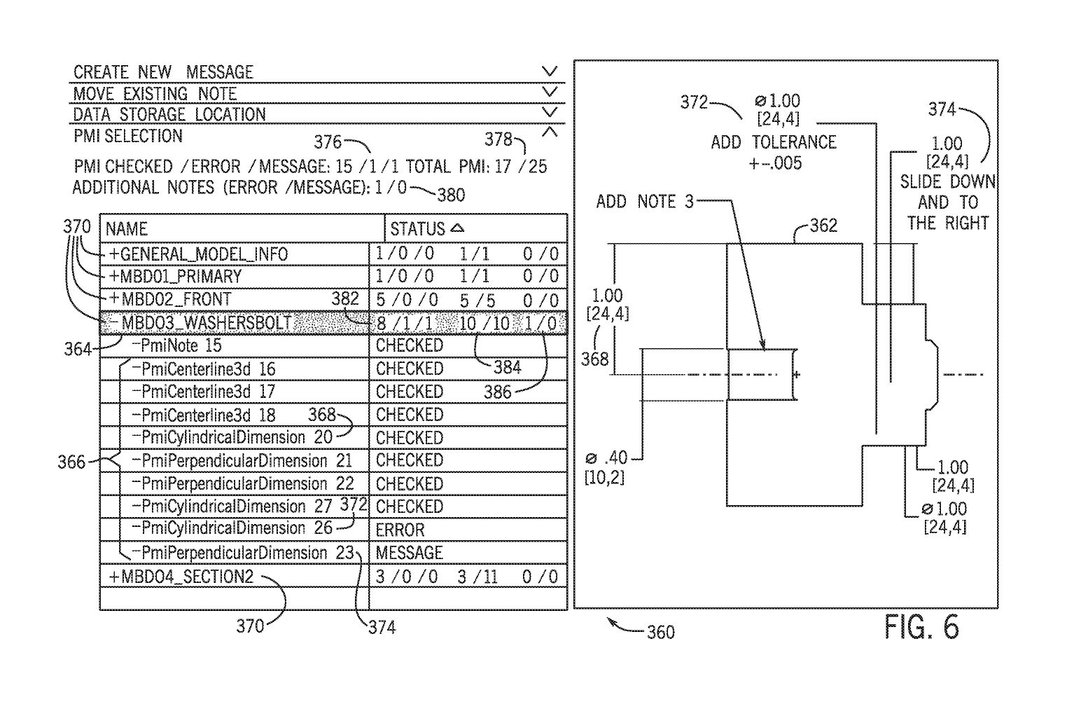

With the foregoing in mind, FIG. 6 is a diagram of graphical content 360 associated with an edited file displayed via execution of the CAD checking application 45. As illustrated, a model 362 is shown in a selected graphical view 364. Each of the programming objects 366 of the model associated with the selected graphical view 364 are listed. In the illustrated embodiment, each of the programming objects 366 are associated with product and manufacturing information (PMI) data. That is, each of the programming objects 366 is associated with a PMI object or is a PMI object. Each of the PMI objects may include information associated with a specific aspect of the power production system 100. For instance, one PMI object may include information related to a face or measurement associated with the turbine 114 while another PMI object may include information related to another component of the power production system 100. Each of the programming objects 366 associated with the selected graphical view 364 may be represented in the model 362 in addition to being listed. For example, the programming object 368 is both shown in the model 362 and listed. Additionally, it should be noted that a user may select one of the unselected graphical views 370, and the model 362 can be shown from the graphical view 370. Moreover, each of the programming objects associated with the graphical view 370 may be listed and displayed within the model 362.

The user may review the programming objects 366 of the model 362. More specifically, while reviewing, the user may select a programming object (e.g., the programming object 368) on the model or on the list and denote whether the user agrees with the programming object, whether the user think a correction to the programming object should be made, or whether the user has a comment, note, or annotation to make regarding the programming object. For instance, in the illustrated embodiment, the user has reviewed the programming objects 368, 372, 374 and denoted that the programming object 368 is correct (i.e., “checked”), noted that the programming object 372 should be corrected (i.e., “error”), and that the programming object 372, and added a comment regarding the programming object 374 (i.e., “message”). In other words, the status of review for a particular programming object may be displayed in the list of programming objects 366.

Moreover, each edit or check by the user may be displayed or denoted in the model 362. For example, the programming object 368, after being indicated as checked (e.g., via a tool provided by the CAD checking application 45), may be displayed in the model 362 with a color distinct from a color for programming objects that have not yet been reviewed, another color for programming objects have been marked as needing correction, and yet another color used to denote programming objects that have had a comment, note, or annotation added. Additionally, regarding programming objects that have been marked as requesting correction or to which a user has added a comment, note, or annotation, information regarding the correction or the comment, note, or annotation may also be displayed with the model 362. For example, as shown in FIG. 6, a user has noted that the programming object 372 should be corrected, and the explanation for the correction to be made is displayed with the model 362 (“Add tolerance +−0.005”). As another example, the user has added a comment associated with the programming object 374, and the comment is displayed with the model 362 (“Slide down and to the right”).

Furthermore, various tallies may be displayed and updated automatically based on user input. More specifically, a first tally 376 may reflect the number of programming objects that the user indicates are correct in the model, the number of programming objects the user indicates should be corrected, and the number of programming objects to which the user has added a comment, note, or annotation. A second tally 378 may reflect the sum of number of programming objects that the user has marked as correct or requesting correction and the programming objects to which the user has added a comment, note, or annotation. The second tally 378 may also include the total number of programming objects associated with the model 362. A third tally 380 may reflect the total number of additional comments a user has left associated with programming objects that the user has indicated should be corrected as well as the number of programming objects to which the user has added a comment, note, or annotation. In other words, the third tally 380 may reflect the numbers of programming objects listed as “error” and “message” to which the user has added a comment. For example, regarding the programming object 374, the user has noted that a correction should be made and has added a comment noting that the correction to be made is to add a specific tolerance. As shown in FIG. 6, the first tally 376 indicates the user has reviewed and agreed with fifteen programming objects, marked that one programming object should be corrected, and that the user has added one comment, note, or annotation associated with one programming object. The second tally 378 indicates that the user has reviewed and/or edited seventeen programming objects out of the twenty-five total programming objects associated with the model 362. The third tally 380 indicates one programming object that the user has indicated should be corrected includes an additional comment.

Additionally, similar tallies may be associated with each of the views 364, 370. That is, there may be a tally 382 that indicates the number of programming objects that the user marks as correct, the number of programming objects the user has indicated should be corrected, and the number of programming objects to which the user has added a comment, note, or annotation. There may also be a tally 384 that reflects the sum of number of programming objects that the user has marked as correct or requesting correction and the programming objects to which the user has added a comment, note, or annotation. The tally 384 may also include the total number of programming objects associated with the view. In addition, there may be another tally 386 indicating the total number of additional comments a user has left associated with programming objects that the user has indicated should be corrected as well as the number of programming objects to which the user has added a comment, noted, or annotation.

It should also be noted that a user may add comments, notes, and annotations that are not associated with a specific programming object. That is, a user may indicate that a correction should be made or may write a message that is not associated with a PMI object. Rather, indications to make corrections or comments may be associated with a specific graphical view. Such messages may be categorized as being an “error” or “message,” and the tallies 380, 386 may reflect such a categorization. In other words, if a user were to add a comment unassociated with any specific programming object associated with the model 362, such a comment would be reflected in the tally 380 indicative of each of the additional notes as well as the tally (e.g., tally 386) specific to the graphical view in which the user added the additional note.

Upon completion of reviewing and/or editing the first file, an edited file (e.g., edited files 212, 222, 232) may be generated. In some embodiments, more than one edited file may be generated for the completed review and/or editing done by a single user. For example, the CAD checking application 45 may allow for a Portable Document Format (PDF) file and a comma-separated values (CSV) file to be generated. The PDF file may include data reflective of graphical representations of the model 362 such as the appearance of the model 362 in each of the graphical views 364, 370. The PDF file may also reflect the review and/or editing completed by the user. For example, the graphical representations of the model 362 saved in the PDF file may also include the comments, notes, or annotations made by a user. The PDF file may also reflect whether the user indicated that the user agrees with a given programming object and/or marked a given programming objects as needing correction. The CSV file may store data associated with the model 362, the programming objects associated with the model, as well as data reflective of the review and/or editing done by the user in plain text. For instance, the CSV file may include a list of each of the programming objects associated with the model 362 and data specific to each of the programming objects.

CSV files may also be read (e.g., from the memory 26 or the network 70) into the CAD checking application 45 and allow a user to see the review and/or edits made by other users. For example, a user may open the first file and load in the CSV files generated based on the review and/or editing completed by other users, and the CAD checking application 45 may instruct the processors 24 to compare the first file to the edited files. More specifically, the CAD checking application 45 may allow for the programming objects of the edited files and attributes associated with the edited files to be compared to the first file and attributes associated with the first file. In some embodiments, upon completion of the comparison of the edited file(s) to the first file, a new file may be generated. As explained above, the new file may include programming objects associated with the model 362 that reflect the differences and similarities between the edited file(s) and the first file.

For example, the new file may include a graphical representation of the model 362, such as what is illustrated in FIG. 6. That is, the new file may allow a user to see the reviews and editing completed by other users. However, it should be noted that the new file may not graphically indicate the programming objects which the other user(s) indicated as being correct. In other words, the graphical representation of the model 362 that is generated upon comparing the edited file(s) to the first file may only include indications of corrections to be made and comments, annotations, or notes made by other users. That is, the user may be presented with a graphical representation of the model 362 that emphasizes or highlights edits made by other users. For instance, the graphical representation of the model 362 may include color indications specific to the type of edits or comments (i.e., “error” indications may be shown in one color while other comments or annotations may be shown in another color). Moreover, the same tallies as described above may also be generated based on the comparison of the edited file(s) to the first file. In other words, tallies indicative of differences between each of the views the model 362 and tallies specific to a selected view of the model 362 may be generated.

In addition to a graphical comparison, the CAD checking application 45 may also generate a file (e.g., a .txt file) that indicates the differences between the first files and the edited file(s). For example, the file may note that one programming object was marked as “error” by one user but that the other users indicated the programming object was correct. The text file may also allow the user to see whether a given user reviewed each of the programming objects. Based on the text file and the graphical representations of the model 362 that are accompanied by the graphical indications of corrections to be made and comments, annotations, or notes made by other users, a user may edit the model 362 to incorporate the review, edits, and/or suggestions or other users.

Moreover, PDF and CSV files may be generated based new files. In other words, after a user has modified a CAD model to reflect feedback and comments included in new files, a PDF and/or CSV file may be generated. Other users may use such a CSV file in the same manner as described above. In other words, a user who created an edited version of the first model may use the CAD checking application 45 and the CSV file from the new file (i.e., the file that incorporates the suggestions of other users) to verify that the user's suggestions were implemented into the model.

Technical effects of the present disclosure include systems and methods for allowing users to review, edit, comment on, or otherwise modify a CAD file, determine the differences and similarities of different versions of a CAD file, and generate a CAD file that specifies the determined differences and similarities. In this manner, multiple users may review and/or edit a version of a CAD file, and a single file specifying the review and/or editing of the users may be generated. By allowing for a single file with all of the review and/or edits of multiple users to be generated, models of parts and components may be made and revised more quickly.

This written description uses examples to of the presently disclosed embodiments, including the best mode, and also to enable any person skilled in the art to practice the disclosed embodiments, including making and using any devices or systems and performing any incorporated methods. The patentable scope of the disclosed embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A tangible, non-transitory, machine-readable medium comprising instructions configured to cause a processor to:
receive a first file associated with a computer-aided design (CAD) model, wherein the first file comprises a first set of programming object data indicative of one or more properties of one or more components of the CAD model;
receive at least one second file, wherein the at least one second file is associated with the CAD model and comprises a second set of programming object data associated with at least one of the one or more properties;
compare the first set of programming object data to the second set of programming object data; and
generate a third file or a graphical representation of the CAD model comprising one or more graphical representations indicative of one or more differences between the first set of programming object data and the second set of programming object data.

2. The tangible, non-transitory, machine-readable medium of claim 1, wherein the instructions are configured to cause the processor to classify the one or more differences between the first set of programming object data and the second set of programming object data when the processor determines a portion of the second plurality of programming object data corresponds to an edited version of a portion of the first set of programming object data, wherein the processor is configured to classify the one or more differences based on one or more types of user input corresponding to editing or reviewing.

3. The tangible, non-transitory, machine-readable medium of claim 2, wherein the one or more graphical representations indicative of one or more differences between the first set of programming object data and the second set of programming object data are indicative of the classification of the one or more differences.

4. The tangible, non-transitory, machine-readable medium of claim 2, wherein the instructions cause the processor to classify the one or more differences based on a request to correct the portion of the first set of programming objects.

5. The tangible, non-transitory, machine-readable medium of claim 4, wherein the instructions cause the processor to classify the one or more differences based on user input indicative of a comment or annotation.

6. The tangible, non-transitory, machine-readable medium of claim 1, wherein the instructions are configured to cause the processor to:
determine whether all of the second set of programming object data has been compared to the first set of programming object data; and
generate an indication in the third file or the graphical representation of the CAD model that at least a portion of the second set of programming object data is the same as a portion of the first set of programming object data when the processor determines that at least the portion of the second set of programming object data is the same as the portion of the first set of programming object data.

7. The tangible, non-transitory, machine-readable medium of claim 1, wherein the third file comprises a third set of programming object data, wherein the third set of programming object data comprises a portion of the first set of programming object data or the second set of programming object data.

8. The tangible, non-transitory, machine-readable medium of claim 1, wherein the instructions are configured to cause the processor to generate a comma-separated values (CSV) file indicative of one or more edits made to the first set of programming object data.

9. The tangible, non-transitory, machine-readable medium of claim 1, wherein the instructions are configured to cause to processor to generate a tally indicative of the one or more differences between the first set of programming object data and the second set of programming object data.

10. A system comprising memory and a processor, wherein the processor is configured to:
receive a first file associated with a computer-aided design (CAD) model, wherein the first file comprises a first set of programming object data;
receive at least one second file, wherein the at least one second file is associated with the CAD model and comprises a second set of programming object data,
compare the first set of programming object data to the second set of programming object data; and
generate a third file or a graphical representation of the CAD model comprising one or more graphical representations indicative of one or more differences between the first set of programming object data and the second set of programming object data.

11. The system of claim 10, wherein the processor is configured to classify the differences between the first set of programming object data and the second set of programming data into a plurality of categories when the processor determines that a portion of the second programming object data corresponds to an edited version of a portion of the first set of programming object data.

12. The system of claim 11, wherein the plurality of categories comprises a first category, wherein the first category comprises one or more differences corresponding to user input indicative that a change to the CAD model has been requested.

13. The system of claim 11, wherein the processor is configured to generate a plurality of tallies indicative of the one or more differences between the first set of programming object data and the second set of programming object data.

14. The system of claim 13, wherein the plurality of tallies comprises a first tally, a second tally, and a third tally, wherein:
the first tally comprises a count of a first number of programming objects a user has indicated are correct, a second number of programming objects for which the user has requested one or more corrections, and a third number of programming objects for which a user has added a comment or annotation; and
the second tally comprises a fourth number of programming objects and a fifth number of programming objects, wherein the fourth number of programming objects corresponds to the sum of the first, second, and third number of programming objects, wherein the fifth number of programming objects corresponds to a total number of programming objects associated with the CAD model.

15. The system of claim 13, wherein the plurality of tallies is specific to a user-selected graphical view of the CAD model.

16. A method comprising,
Receiving, via a processor, a first file associated with a computer-aided design (CAD) model, wherein the first file comprises a first set of programming object data;
receiving at least one second file, wherein the at least one second file is associated with the CAD model and comprises a second set of programming object data,
comparing, via the processor, the first set of programming object data to the second set of programming object data; and
generating, via the processor, a third file or a graphical representation of the CAD model comprising one or more graphical representations indicative of one or more differences between the first set of programming object data and the second set of programming object data.

17. The method of claim 16, comprising classifying, via the processor, the one or more differences between the first set of programming object data and the second set of programming data when the processor determines that a portion of the second programming object data corresponds to an edited version of a portion of a set of programming object data.

18. The method of claim 17, comprising displaying, via the processor, colored indications based on the classification of the one or more differences between the first set of programming object data and the second set of programming data.

19. The method of claim 16, comprising generating, via the processor, data indicative that a second portion of the second data does not correspond to an edited version of a second portion of the first set of programming object data.

20. The method of claim 16, wherein the at least one second file is a comma-separated values file.
